(19) United States
(12) Patent Application Publication
(10) Pub. No.: US 2016/0224989 A1
(43) Pub. Date: Aug. 4, 2016

(54) DISTRIBUTED LICENSE AUTHENTICATION AND MANAGEMENT

(71) Applicant: BitTorrent, Inc., San Francisco, CA (US)

(72) Inventors: Konstantin Lissounov, Albany, CA (US); Sergey Matalytski, Minsk (BY)

(21) Appl. No.: 15/009,965

(22) Filed: Jan. 29, 2016

Related U.S. Application Data
(60) Provisional application No. 62/110,459, filed on Jan. 30, 2015.

(51) Int. Cl. G06Q 30/00; G06F 9/445; H04L 9/32; G06F 21/10

(52) U.S. Cl. CPC G06Q 30/0185; G06F 21/105; G06F 8/61; H04L 9/32; G06Q 2220/18; G06F 2221/0773

(57) ABSTRACT

Systems and methods for licensing a licensor software installation using P2P technology are provided. A computer program product for licensing a licensor software installation for a user includes instructions for receiving a license key for the licensor software and creating a license folder corresponding to the license key. The license folder includes a read-only cryptographic key to use for the license folder to validate the contents of the license folder and a list of users with a license. Additional instructions include adding the user to the list of users with a license and distributing the license folder to a device associated with the user to license the licensor software installation for the user. According to some embodiments, this enables licensing authentication and management for the licensor software in a distributed and serverless way. This may prevent unlicensed use of the licensor software and/or allow licensed use without a licensing server.

### RELATED APPLICATIONS

This application claims the benefit of provisional patent application Ser. No. 62/110,459, filed Jan. 30, 2015, the disclosure of which is hereby incorporated herein by reference in its entirety.

### FIELD OF THE DISCLOSURE

The present disclosure relates to licensing software.

### BACKGROUND

A particular piece of software, or computer program product, may be made available to users in many ways. Some pieces of software are free to use with no or few restrictions. Some pieces of software require a license in order to legally use the software. License requirements can be enforced in many ways, and the requirements for obtaining a license may include such things as providing information regarding the user or payment to the licensor. In order to avoid a requirement for obtaining a license to the software, a user may circumvent these enforcement mechanisms.

FIG. 1 illustrates an example system 10 for server-based licensing of software. In this example, a server 12 (also referred to as a licensing server 12) may be associated with a licensor of a software. The system 10 shows the licensing server 12 providing information, such as a licensing key, to various client devices 14-1 through 14-4 (also referred to as client device 14 or client devices 14). This license key allows the licensor software to operate on each of the client devices 14. However, if there is any loss of connectivity to the licensing server 12 from a client device 14, the licensor software may not be able to be licensed and may not operate as the licensor desires.

### SUMMARY

Systems and methods for operating a device for licensing a licensor software installation using Peer-to-Peer (P2P) technology are provided. In some embodiments, a computer program product for operating a device for licensing a licensor software installation for a user includes instructions for receiving a license key for the licensor software and creating a license folder corresponding to the license key. The license folder includes a read-only cryptographic key to use for the license folder to validate the contents of the license folder and a list of users with a license to the licensor software.

Additional instructions are for adding the user to the list of users with a license to the licensor software and distributing the license folder to a second device associated with the user to license the licensor software installation for the user. According to some embodiments, this enables licensing authentication and management for the licensor software in a distributed and serverless way. This may prevent unlicensed use of the licensor software and/or allow licensed use without communication with a licensing server.

In some embodiments, receiving the license key includes receiving the license key for the licensor software from a licensing server associated with the licensor software.

In some embodiments, the license key for the licensor software includes: a maximum number of users allowed to be licensed by the license key; an expiration date of the license key; a read-write cryptographic key to use for the license folder corresponding to the license key; and the read-only cryptographic key to use for the license folder corresponding to the license key.

In some embodiments, creating the license folder includes creating the license folder corresponding to the license key using the read-write cryptographic key of the license key; and the license folder also includes the maximum number of users allowed to be licensed by the license key and the expiration date of the license key.

In some embodiments, the list of users with a license to the licensor software includes a list of user identity objects corresponding to the list of users with a license to the licensor software where each user identity object includes a public key and a name associated with the corresponding user.

In some embodiments, the computer program instructions are further for removing the user from the list of users with a license to the licensor software; and distributing the license folder corresponding to the license key to the second device associated with the user to unlicense the licensor software installation for the user.

In some embodiments, distributing the license folder comprises distributing the license folder to the second device via a P2P network. In some embodiments, the computer program product is the licensor software. In some embodiments, the computer program product is BitTorrent Sync.

In some embodiments, a computer program product for operating a device for licensing a licensor software installation for a user associated with the device is provided. The computer program product having a non-transitory computer-readable storage medium having computer program instructions for receiving a license folder corresponding to a license key for the licensor software. The license folder includes a read-only cryptographic key to use for the license folder to validate the contents of the license folder; and a list of users with a license to the licensor software. The computer program instructions are also for determining if the user is licensed to use the licensor software by determining if the user is on the list of users with a license to the licensor software; and, in response to determining that the user is licensed to use the licensor software, licensing the licensor software installation for the user.

In some embodiments, the license folder also includes a maximum number of users allowed to be licensed by the license key; and determining if the user is licensed to use the licensor software also includes determining if the user is within a group of first N users on the list of users where N is the maximum number of users allowed to be licensed by the license key.

In some embodiments, the license folder also includes an expiration date of the license key; and determining if the user is licensed to use the licensor software also includes determining if the current time is before the expiration date of the license key. In some embodiments, determining if the user is licensed to use the licensor software also includes determining if the license folder has been updated within a predetermined time.

In some embodiments, the computer program instructions are further for: receiving an updated license folder corresponding to the license key for the licensor software; determining if the user is licensed to use the licensor based on the updated license folder; and, in response to determining that the user is licensed to use the licensor software, licensing the licensor software installation for the user. In some embodiments, receiving the updated license folder includes determining that the updated license folder has been modified more recently than the license folder and that the updated license folder has been validated using the read-only cryptographic key to use for the license folder to validate the contents of the license folder.

In some embodiments, the list of users with a license to the licensor software includes a list of user identity objects corresponding to the users with a license to the licensor software where each user identity object includes a public key and a name associated with the corresponding user.

In some embodiments, distributing the license folder comprises distributing the license folder to the second device via a P2P network. In some embodiments, the computer program product is the licensor software. In some embodiments, the computer program product is BitTorrent Sync.

In some embodiments, a device includes a communication interface configured to communicatively couple the device to a second device and circuitry. The circuitry is configured to receive, via the communication interface from a licensing server associated with a licensor software, a license key for the licensor software. The circuitry is also configured to create, on the device, a license folder corresponding to the license key. The license folder includes a read-only cryptographic key to use for the license folder to validate the contents of the license folder and a list of users with a license to the licensor software. The circuitry is also configured to add a user to the list of users with a license to the licensor software and distribute the license folder corresponding to the license key to a second device associated with the user to license the licensor software installation for the user.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 illustrates an example system for server-based licensing of software.

FIG. 2 illustrates an exemplary system for Peer-to-Peer (P2P)-based licensing of software, according to some embodiments of the present disclosure.

FIG. 3 illustrates a method of operating a device for licensing a licensor software installation for a user, according to some embodiments of the present disclosure.

FIG. 4 illustrates a method of operating a device for licensing a licensor software installation for a user associated with the device, according to some embodiments of the present disclosure.

FIG. 5 illustrates a flowchart for creating a license folder on a device and sharing the license folder with a second device associated with a user, according to some embodiments of the present disclosure.

FIG. 6 illustrates a system for transmitting files using P2P technology, according to some embodiments of the present disclosure.

FIG. 7 illustrates a flowchart for transmitting a license folder using P2P technology in order to synchronize the license folder, according to some embodiments of the present disclosure.

FIG. 8 is a block diagram of a device, according to some other embodiments of the present disclosure.

FIG. 9 is a block diagram of a device with modules for licensing a licensor software installation for a user, according to some embodiments of the present disclosure.

FIG. 10 is a block diagram of a device with modules for licensing a licensor software installation for a user associated with the device, according to some embodiments of the present disclosure.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

Systems and methods for operating a device for licensing a licensor software installation using Peer-to-Peer (P2P) technology are provided. In some embodiments, a computer program product for operating a device for licensing a licensor software installation for a user includes instructions for receiving a license key for the licensor software and creating a license folder corresponding to the license key. The license folder includes a read-only cryptographic key to use for the license folder to validate the contents of the license folder and a list of users with a license to the licensor software. Additional instructions are for adding the user to the list of users with a license to the licensor software and distributing the license folder to a second device associated with the user to license the licensor software installation for the user. According to some embodiments, this enables licensing authentication and management for the licensor software in a distributed and serverless way. This may prevent unlicensed use of the licensor software and/or allow licensed use without communication with a licensing server.

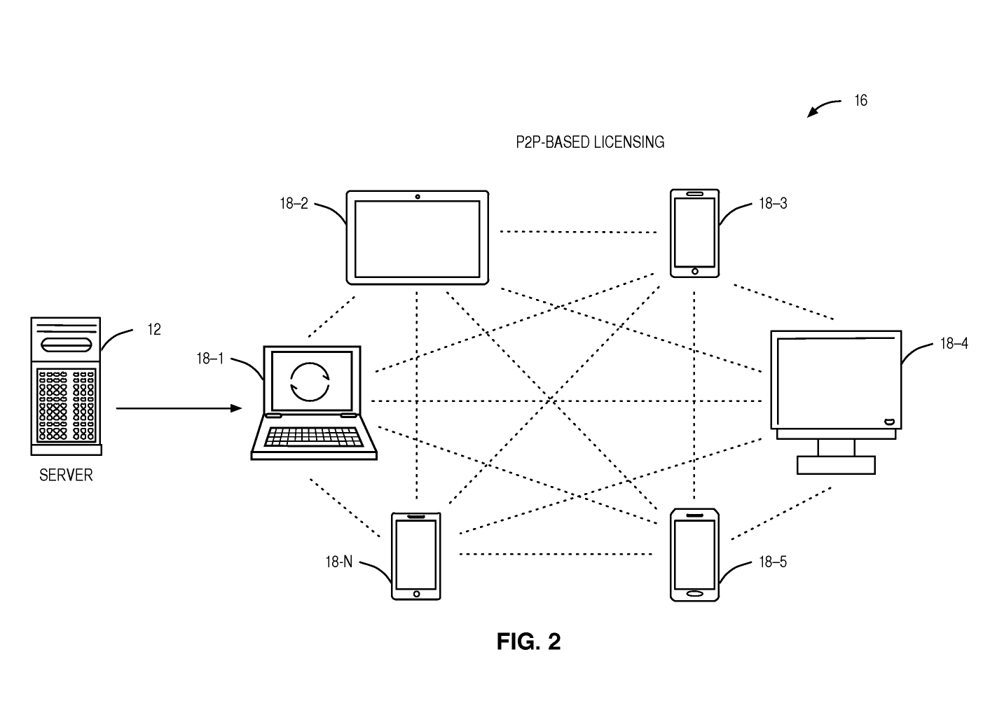

FIG. 2 illustrates an exemplary system 16 for P2P-based licensing of licensor software, according to some embodiments of the present disclosure. Various devices 18-1 through 18-N (also referred to as device 18 or devices 18) are in communication with each other. In some embodiments, each device 18 can communicate with each other device 18, while in other embodiments, a device 18 may only be able to communicate with a subset of the other devices 18.

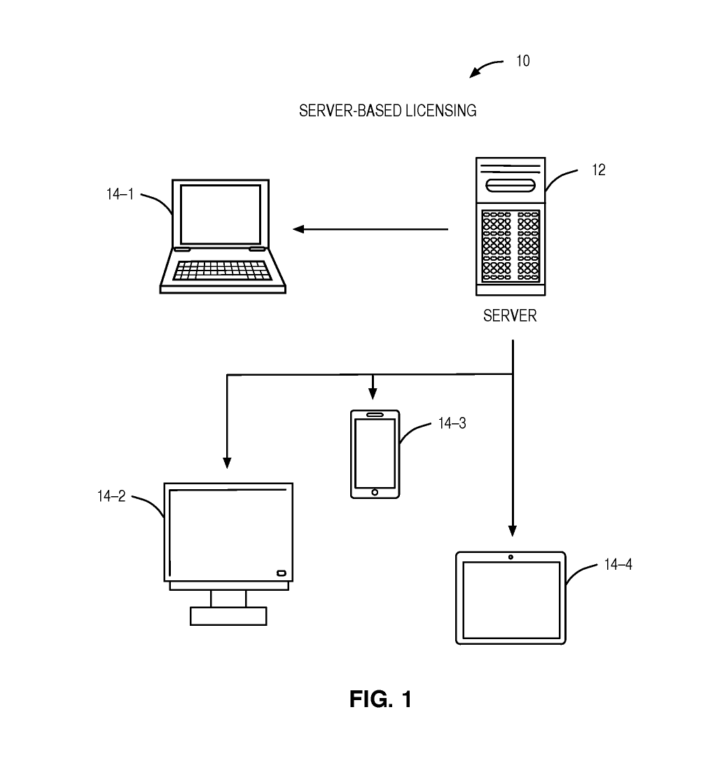

Instead of each device 18 communicating with a licensing server 12 as shown in FIG. 1, a device 18 may obtain the information needed to license the licensor software from one or more of the other devices 18. When such sharing occurs, the devices 18 may be referred to as peers. In some embodiments, a distributed serverless way of license authentication is provided. Some of these embodiments are based on cryptographic security where each node in a P2P network (such as devices 18) not only validates its own license but also is able to validate site licenses.

In some embodiments, a device 18-1 may be in communication with the licensing server 12 or some other information provider. This communication may be, for example, to receive a license key for the licensor software or for receiving updates to the license key. In some embodiments, the initial user that consumes a license (such as a user associated with device 18-1) becomes the owner of the license. Other users can be invited to consume unused licenses. A license owner can revoke a consumed license at any time.

In some embodiments, consumption and authentication of licenses is fully distributed and uses only private infrastructure. License information is synchronized across all devices consuming the same licenses. Validation of the identity of the other users with whom the license owner shares the licenses is not performed by the licensor.

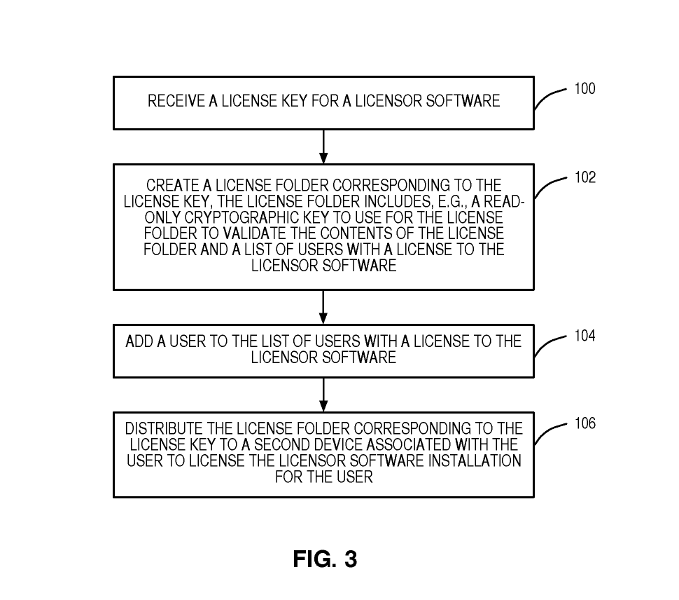

FIG. 3 illustrates a method of operating a device 18 for licensing a licensor software installation for a user, according to some embodiments of the present disclosure. First, the device 18 receives a license key for the licensor software (step 100). In some embodiments, this may be received from a licensing server associated with the licensor software, such as licensing server 12, or from any other suitable location.

In some embodiments, when a user purchases a license from the licensor, the user receives a license key which includes the following information:

Part 1:
number of allowed users
expiration date
a read-write key for a licensor software shared folder

Part 2:
number of allowed users
expiration date
a read-only key for the licensor software shared folder

In some embodiments, every part of the license is separately signed by a licensor private key. This way any licensor software installation can validate the integrity of the license information.

The device 18 then creates a license folder corresponding to the license key (step 102). The license folder includes, e.g., a read-only cryptographic key to use for the license folder to validate the contents of the license folder and a list of users with a license to the licensor software. For every license key, there is a corresponding licensor software shared folder created (referred to herein as a “license folder”). The license folder is used to manage the list of users associated with the license. The license owner has read-write access to the license folder and non-owner users have read-only access to the folder. The license owner has access to both parts of the license, this way the license owner can get read-write permission to license folder.

Further, the license owner adds Part 2 of the license to the license folder, which additionally contains a list of user identity objects for all users who can consume the license. In some embodiments, an identity object includes a user public key and a user name. Every identity object is stored as an individual file in the license folder. Additionally, the license folder includes a file with public license information (e.g., Part 2 information or a license certificate) which includes a number of allowed users and an expiration date.

Next, the device 18 adds a user to the list of users with a license to the licensor software (step 104). This may include adding the user's user name to the list of users with a license, or the license owner can invite new users to consume the license by adding their user identifies to the license folder. Additionally, the license owner can disconnect existing users by removing their user identities from the license folder.

In order for a user of a second device 18 to consume the license and operate the licensor software, the license folder must be on that second device 18. Therefore, the device 18 distributes the license folder corresponding to the license key to the second device 18 associated with the user to license the licensor software installation for the user (step 106). All files inside the license folder are automatically synchronized by the licensor software or in some other way, between all users and devices 18 who are supposed to share the same license.

This automatic synchronization could be accomplished in any suitable way. One way is to use BitTorrent Sync and any suitable methods described in the U.S. patent application Ser. No. 14/975,361 entitled “Distributed Device Management and Directory Resolution” filed on Dec. 18, 2015 and incorporated herein by reference. Some aspects of that disclosure are further discussed below.

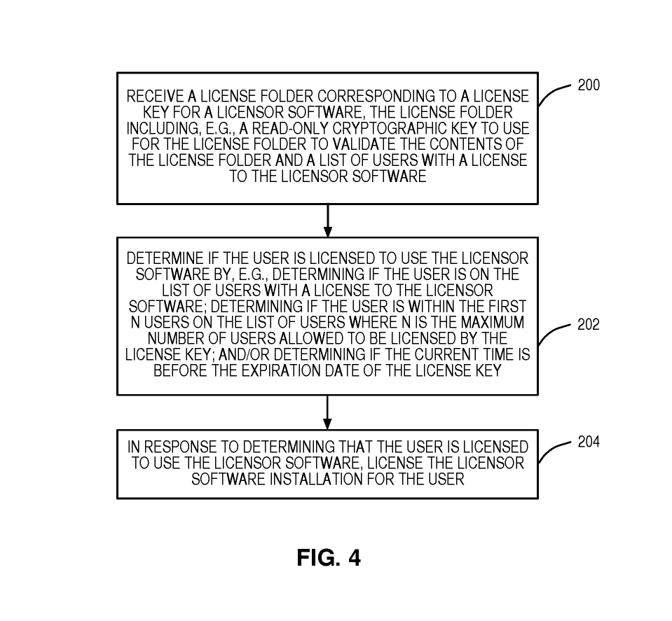

FIG. 4 illustrates a method of operating a device 18 for licensing a licensor software installation for a user associated with the device 18, according to some embodiments of the present disclosure. First, the device 18 receives a license folder corresponding to a license key for a licensor software (step 200). The license folder may include, e.g., a read-only cryptographic key to use for the license folder to validate the contents of the license folder and a list of users with a license to the licensor software, as discussed above.

The device 18 then determines if the user is licensed to use the licensor software (step 202). In some embodiments, this determination may be accomplished by any combination of determining if the user is on the list of users with a license to the licensor software; determining if the user is within the first N users on the list of users where N is the maximum number of users allowed to be licensed by the license key; and/or determining if the current time is before the expiration date of the license key.

In response to determining that the user is licensed to use the licensor software, the device 18 licenses the licensor software installation for the user (step 204). This may include the licensor software operating as intended and without restrictions that may be imposed on users who are not licensed to use the licensor software.

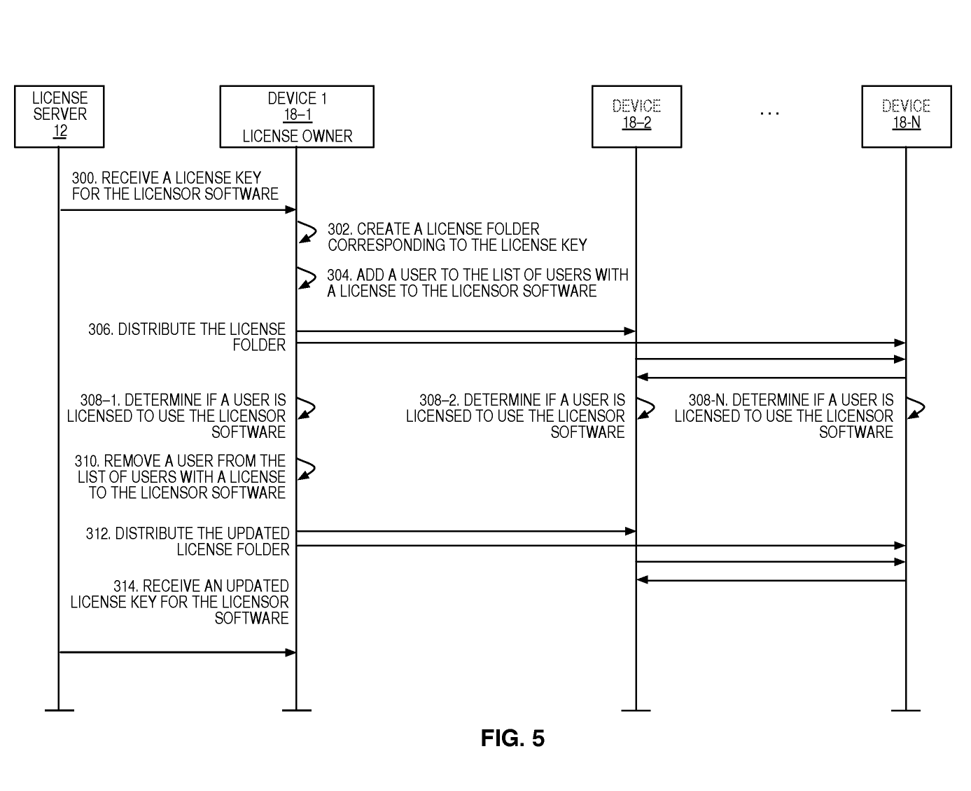

The methods discussed so far can operate together to provide distributed license authentication and management. In this regard, FIG. 5 illustrates a flowchart for creating a license folder on a device 18 and sharing the license folder with a second device 18 associated with a user, according to some embodiments of the present disclosure.

As shown in FIG. 5, the device 18-1 (shown as the “license owner”) receives a license key for the licensor software from the license server 12 as discussed above (step 300). The device 18-1 then creates a license folder corresponding to the license key (step 302) and adds a user to the list of users with a license to the licensor software (step 304). While only one user is discussed here, many users may potentially be added, depending on the license for the licensor software. For instance, an administrator of a company may add each employee or some group of employees to the list.

The user associated with device 18-1, as the license owner, is the only one able to modify/write to the license folder. Therefore, at this stage, the device 18-1 is the only copy of the current license folder, and this needs to be distributed to the other devices 18. FIG. 5 shows that the device 18-1 distributes the license folder to other devices 18 (step 306). This figure also shows that the distribution may take place in multiple directions as discussed for a P2P network.

At this point, each device 18 that needs the license folder has a copy. Now, a user associated with any of these devices 18 can attempt to access the licensor software. If that happens, the device 18 can determine if the user is licensed to use the licensor software (steps 308-1 through 308-N). Note that not all devices 18 will attempt to access the licensor software at this time. Also, each device 18 could have a different associated user, or some or all of the devices 18 may be associated with the same user. As discussed above, this determination enables licensing authentication and management for the licensor software in a distributed and serverless way. This may prevent unlicensed use of the licensor software and/or allow licensed use without communication with a licensing server.

Next, FIG. 5 shows that the device 18-1 may also remove a user from the list of users with a license to the licensor software (step 310). This would serve to unlicense the user, e.g., prevent the user from accessing the licensor software. But, in order for a different device 18 to know that this user is no longer to be licensed, that device 18 needs the updated license folder. Therefore, similarly to step 306 above, the device 18-1 distributes the license folder to other devices 18 (step 312). At this point, if the removed user attempts to use the licensor software, the associated device 18 will be able to determine that the user is not licensed based on the updated license folder.

In some embodiments, in an attempt to ensure that the license folder is up to date and accurately reflects which users are licensed to use the licensor software, a device 18 will attempt to update the license folder prior to determining if a user is licensed to use the licensor software. Further, in some embodiments, a device 18 may refuse to allow access to a user if the license folder has not been updated within a predetermined amount of time. In some embodiments, this test for staleness might also be accomplished by setting the expiration date of the license to a time that is sooner than might be used otherwise. This will require the device 18 to acquire an updated license folder with a new expiration date, or no users will be able to access the licensor software.

Since license folder keys are embedded in both the license string or file and also the license folder, any valid license string or file has to use the license folder for the license to function. Therefore, any license used will be added to this folder and the license counter will count the use against the permitted number under the original license. Additionally, because a node with a license can have any IP address, blocking an IP address range of known servers is unlikely to avert the limited license count.

Some updates may be made by the device 18-1, the license owner. Also, the device 18-1 may be in communication with the licensing server 12 to receive an updated license key for the licensor software (step 314). This update might include a change to the maximum number of users that can be licensed at a time or the expiration date of the license, as examples. Depending on the changes, the device 18-1 may need to update the license folder and again distribute the updated version to the other devices 18.

The previous figures and discussion mostly allude to the license folder being synchronized or distributed between the devices 18. The device 18 could get this license folder in any suitable way. One such way is to use the BitTorrent protocol or some other P2P technology to get the license folder from other devices 18 that have the updated version (e.g., peers). Using such a technique allows the system to work without the use of a central server, as discussed above.

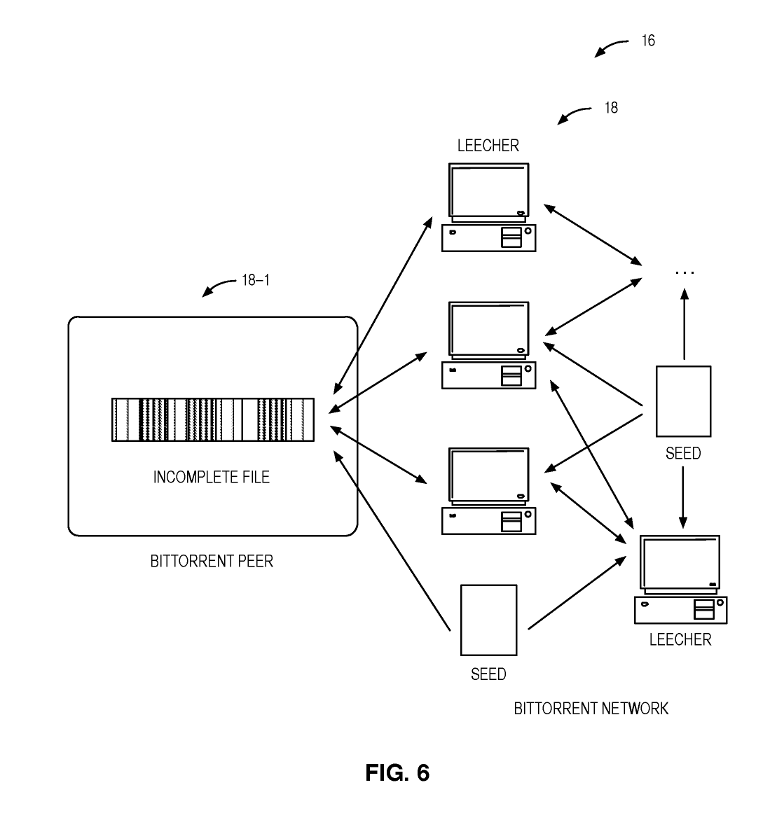

FIG. 6 illustrates a system for transmitting files such as the license folder using P2P technology, according to some embodiments of the present disclosure. The device 18-1 has determined that a file in the license folder needs to be updated, perhaps using any of the techniques described above. In FIG. 6, the device 18-1 is labeled as the “BitTorrent Peer,” and the other devices 18 are labeled as the “BitTorrent Network.” As shown, device 18-1 includes an incomplete version of the file (perhaps starting with no parts of the file). Also as shown, the peers in the BitTorrent Network can be either seeds or leechers. A seed is a peer that has the complete file and is sharing pieces of it. A leecher is a peer that does not have the complete file and is therefore accepting pieces as well as possibly sharing some pieces.

According to some P2P technologies, such as the BitTorrent protocol, the device 18-1 may receive pieces from one or more peers at the same time. Also, if there is another peer that needs to complete the file, the device 18-1 may transfer pieces of the file to those peers, if possible, even before a complete copy of the file has been acquired. Using such a technology, the file does not need to be located on a central server. Also, instead of additional users potentially slowing the transfer speeds as in a central server based system, additional users may provide increased transfer speeds as pieces may arrive from different peers in different networks.

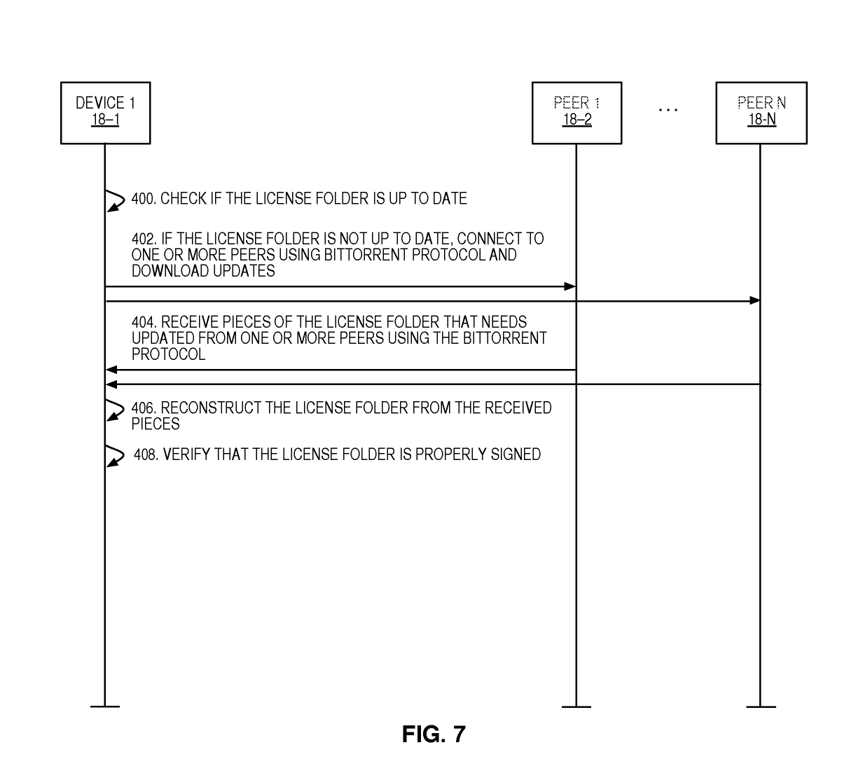

FIG. 7 illustrates a flowchart for transmitting a license folder using P2P technology in order to synchronize the license folder, according to some embodiments of the present disclosure. In this figure, only the device 18-1 is considered for receiving the files for simplicity. However, in practice, the peers may have files or pieces of files that the device 18-1 is also able to provide.

The device 18-1 checks if the license folder is up to date (step 400). This may be accomplished using any method discussed herein or any other suitable way. If the license folder is not up to date, the device 18-1 connects to one or more peers using the BitTorrent protocol and downloads updates (step 402). The device 18-1 receives pieces of the license folder that need updated from one or more peers using the BitTorrent protocol (step 404). Once all of the pieces for a file are received, the device 18-1 reconstructs the license folder from the received pieces (step 406). When all files are reconstructed, the device 18-1 can verify that the license folder is properly signed (step 408). In embodiments that use a license key or certificate that is signed by the licensor, or other trusted entity, in the license folder, this may be accomplished by validating the signatures.

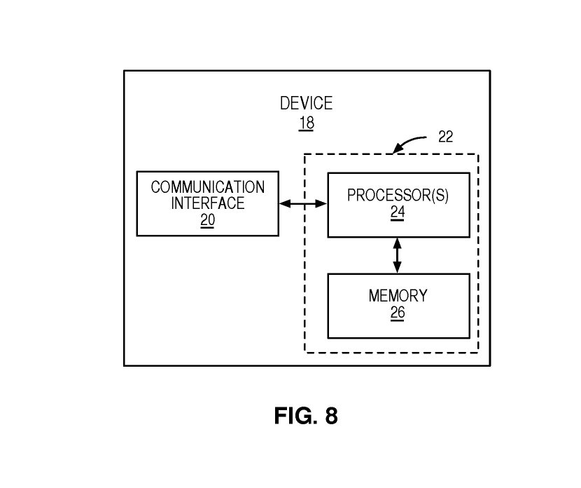

FIG. 8 is a block diagram of a device, according to some other embodiments of the present disclosure. The device 18 includes a communication interface 20 for communication with other devices 18. The device 18 also includes circuitry 22 that includes one or more processors 24 which may be one or more Central Processing Units (CPUs) for performing any of the processes described herein. Circuitry 22 also includes a memory 26 (e.g. non-volatile and/or volatile memory, such as hard drive, flash memory, memory stick and the like). Also, volatile memory may include random access memory and others known in the art. Memory 26 may store program instructions such as those to perform the functionality described herein.

In some embodiments, a carrier containing the aforementioned program instructions is provided. The carrier is one of an electronic signal, an optical signal, a radio signal, or a computer readable storage medium (e.g., a non-transitory computer readable medium).

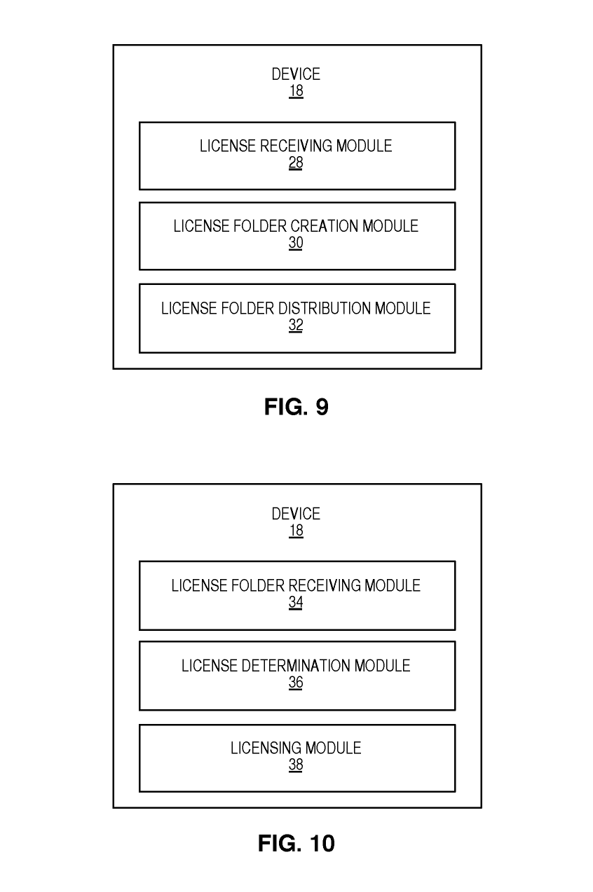

FIG. 9 is a block diagram of a device with modules for licensing a licensor software installation for a user, according to some embodiments of the present disclosure. A license receiving module 28, a license folder creation module 30, and a license folder distributing module 32 are implemented in software that, when executed by a processor of device 18, causes the device 18 to operate according to one of the embodiments described herein.

FIG. 10 is a block diagram of a device with modules for licensing a licensor software installation for a user associated with the device, according to some embodiments of the present disclosure.

A license folder receiving module 34, a license determination module 36, and a licensing module 38 are implemented in software that, when executed by a processor of device 18, causes the device 18 to operate according to one of the embodiments described herein.

Those skilled in the art will recognize improvements and modifications to the preferred embodiments of the present disclosure. All such improvements and modifications are considered within the scope of the concepts disclosed herein and the claims that follow.

What is claimed is:

1. A computer program product for operating a device for licensing a licensor software installation for a user, the computer program product having a non-transitory computer-readable storage medium having computer program instructions for:
receiving a license key for the licensor software;
creating a license folder corresponding to the license key, the license folder comprising:
a read-only cryptographic key to use for the license folder to validate the contents of the license folder; and
a list of users with a license to the licensor software;
adding the user to the list of users with a license to the licensor software; and
distributing the license folder corresponding to the license key to a second device associated with the user to license the licensor software installation for the user.

2. The computer program product of claim 1 wherein receiving the license key comprises receiving the license key for the licensor software from a licensing server associated with the licensor software.

3. The computer program product of claim 1 wherein the license key for the licensor software comprises:
a maximum number of users allowed to be licensed by the license key;
an expiration date of the license key;
a read-write cryptographic key to use for the license folder corresponding to the license key; and
the read-only cryptographic key to use for the license folder corresponding to the license key.

4. The computer program product of claim 3 wherein:
creating the license folder comprises creating the license folder corresponding to the license key using the read-write cryptographic key of the license key; and
the license folder further comprises the maximum number of users allowed to be licensed by the license key and the expiration date of the license key.

5. The computer program product of claim 1 wherein the list of users with a license to the licensor software comprises a list of user identity objects corresponding to the list of users with a license to the licensor software where each user identity object comprises a public key and a name associated with the corresponding user.

6. The computer program product of claim 1 wherein the computer program instructions are further for:
removing the user from the list of users with a license to the licensor software; and
distributing the license folder corresponding to the license key to the second device associated with the user to unlicense the licensor software installation for the user.

7. The computer program product of claim 1 distributing the license folder comprises distributing the license folder to the second device via a Peer-to-Peer (P2P) network.

8. The computer program product of claim 1 wherein the computer program product is the licensor software.

9. The computer program product of claim 8 wherein the computer program product is BitTorrent Sync.

10. A computer program product for operating a device for licensing a licensor software installation for a user associated with the device, the computer program product having a non-transitory computer-readable storage medium having computer program instructions for:
receiving a license folder corresponding to a license key for the licensor software, the license folder comprising:
a read-only cryptographic key to use for the license folder to validate the contents of the license folder; and
a list of users with a license to the licensor software;
determining if the user is licensed to use the licensor software by determining if the user is on the list of users with a license to the licensor software; and
in response to determining that the user is licensed to use the licensor software, licensing the licensor software installation for the user.

11. The computer program product of claim 10 wherein:
the license folder further comprises a maximum number of users allowed to be licensed by the license key; and
determining if the user is licensed to use the licensor software further comprises determining if the user is within a group of first N users on the list of users where N is the maximum number of users allowed to be licensed by the license key.

12. The computer program product of claim 10 wherein:
the license folder further comprises an expiration date of the license key; and
determining if the user is licensed to use the licensor software further comprises determining if the current time is before the expiration date of the license key.

13. The computer program product of claim 10 wherein determining if the user is licensed to use the licensor software further comprises determining if the license folder has been updated within a predetermined time.

14. The computer program product of claim 10 wherein the computer program instructions are further for:
receiving an updated license folder corresponding to the license key for the licensor software;
determining if the user is licensed to use the licensor based on the updated license folder; and
in response to determining that the user is licensed to use the licensor software, licensing the licensor software installation for the user.

15. The computer program product of claim 14 wherein receiving the updated license folder comprises determining that the updated license folder has been modified more recently than the license folder and that the updated license folder has been validated using the read-only cryptographic key to use for the license folder to validate the contents of the license folder.

16. The computer program product of claim 10 wherein the list of users with a license to the licensor software comprises a list of user identity objects corresponding to the users with a license to the licensor software where each user identity object comprises a public key and a name associated with the corresponding user.

17. The computer program product of claim 10 wherein distributing the license folder comprises distributing the license folder to the second device via a Peer-to-Peer (P2P) network.

18. The computer program product of claim 10 wherein the computer program product is the licensor software.

19. The computer program product of claim 18 wherein the computer program product is BitTorrent Sync.

20. A device, comprising:
a communication interface configured to communicatively couple the device to a second device; and
circuitry configured to:
receive, via the communication interface from a licensing server associated with a licensor software, a license key for the licensor software;
create, on the device, a license folder corresponding to the license key, the license folder comprising:
a read-only cryptographic key to use for the license folder to validate the contents of the license folder; and
a list of users with a license to the licensor software;
add a user to the list of users with a license to the licensor software; and
distribute the license folder corresponding to the license key to a second device associated with the user to license the licensor software installation for the user.
